(19) United States
(12) Patent Application Publication
(10) Pub. No.: US 2024/0424555 A1
(43) Pub. Date: Dec. 26, 2024

(54) METHOD OF MANUFACTURE OF PRODUCTS FROM REGOLITH, 3D PRINTING METAL RESIDUES AND ALIKE USING HIGH TEMPERATURE

(71) Applicant: Kilncore Inc., Sutton (CA)

(72) Inventor: Antoine MISSOUT, Sutton (CA)

(21) Appl. No.: 18/039,261

(22) PCT Filed: Feb. 17, 2023
(86) PCT No.: PCT/CA2023/050206

§ 371 Date: May 29, 2023

Related U.S. Application Data
(60) Provisional application No. 63/311,302, filed on Feb. 17, 2022.

(51) Int. Cl. B22F 3/12; B22F 10/32; B22F 10/368; B33Y 10/00; B33Y 40/20; B33Y 80/00

(52) U.S. Cl. CPC B22F 3/12; B22F 10/32; B22F 10/368; B33Y 10/00; B33Y 40/20; B33Y 80/00

(57) ABSTRACT

A method of manufacturing filters from regolith or 3d printing metal residues is presented, the method comprising (a) laying down a layer of particles of regolith or 3d printing metal residues into a mold; (b) closing the mold; (c) in-mold processing the regolith or 3d printing metal residues present in the mold by injecting pressurized gas into the mold and heating up the under-pressure regolith or 3d printing metal residues to exert the particles of regolith or 3d printing metal residues to fuse at least partially with each other without regolith or 3d printing metal residues melting; (d) decreasing temperature in the mold, depressurizing the mold, and opening the mold; repeating steps (a) to (d) at least once, wherein the particles of regolith or 3d printing metal residues of the step (a) are laid over the in-mold-processed regolith or 3d printing metal residues; and following the in-mold processed regolith or 3d printing metal residues reaching a desired parameter, demolding the in-mold processed regolith or 3d printing metal residues to obtain the regolith or 3d printing metal residues filter.

### CROSS-REFERENCE TO RELATED APPLICATION

This application relates to and is a non-provisional application claiming priority under 35 U.S.C. § 119 (e) from U.S. provisional patent application Ser. No. 63/311,302, filed Feb. 17, 2022), entitled PROCESSING OF REGOLITH USING HIGH-TEMPERATURE AND HIGH-PRESSURE, the specification of which is hereby incorporated herein by reference in its entirety.

### BACKGROUND

### (A) Field

The subject matter disclosed generally relates to devices and methods for processing regolith, 3d printing metal residues, or alike. More particularly, the subject matter disclosed relates to devices and methods for processing regolith or 3d printing metal residues in normal to low gravity environment to generate a manufactured product such as a filter or a thermal shield.

### (b) Related Prior Art

In a period when lunar stations are becoming more and more realistic in the upcoming decencies, there is a need for devices and methods for exploitation in situ of the resources available on the Moon.

Based on the different conditions on the surface of the moon than on Earth, in addition to the costs of transportation of material from Earth to the Moon, devices and methods used on Earth are not always the best option, and frequently an option to avoid.

Accordingly, nowadays there is a need for innovation applicable to in situ exploitation of the resources present on the Moon.

### SUMMARY

In some aspects, the techniques described herein relate to a method of manufacturing an in-mold manufactured article, comprising: (a) laying down into a mold a first layer of particles of a material comprising at least one of a) at least 50% of non-regular particles, and b) at least 60% of particles of a size greater than 80 microns; (b) closing the mold; (c) in-mold processing the first layer of particles present in the mold by heating up content of the mold to exert the particles of the material to fuse at least partially with each other to generate a first manufactured layer; (d) decreasing temperature; repeating steps (a) to (d) at least once, whereby a second layer of particles of the material is laid over the first manufactured layer to obtain a second manufactured layer at least partially fused with the first manufactured layer; and demolding the in-mold manufactured article comprising the first manufactured layer and the second manufactured layer. Resulting from that technique, in at least one of the first manufactured layer and the second manufactured layer, the particles are at least partially fused without having melt.

In some aspects, the techniques described herein relate to a method of manufacturing an in-mold manufactured article, wherein the step of in-mold processing includes controlling gas pressure into the mold.

In some aspects, the techniques described herein relate to a method of manufacturing an in-mold manufactured article, wherein the step of in-molding processing the first layer of particles includes fusing the particles into a cohesive gas tight manufactured layer.

In some aspects, the techniques described herein relate to a method of manufacturing an in-mold manufactured article, wherein the step of in-molding processing the second layer of particles includes fusing partially the particles into a cohesive porous manufactured layer.

In some aspects, the techniques described herein relate to a method of manufacturing an in-mold manufactured article, wherein the step of in-mold processing the first layer of particles includes controlling gas pressure to a first pressure, and wherein the step of in-mold processing the second layer of particles includes controlling gas pressure to a second pressure lower than the first pressure.

In some aspects, the techniques described herein relate to a method of manufacturing an in-mold manufactured article, wherein the step of in-mold processing the first layer of particles includes heating the content of the mold to a first temperature, and wherein the step of in-mold processing the second layer of particles includes heating the content of the mold to a second temperature different from the first temperature.

In some aspects, the techniques described herein relate to a method of manufacturing an in-mold manufactured article, wherein the step of laying down the first layer of particles includes laying down the particles into a first thickness of particles, and where the step of laying down the second layer of particles includes laying down the particles into a second thickness of particles different from the first thickness of particles.

In some aspects, the techniques described herein relate to a method of manufacturing an in-mold manufactured article, wherein the step of laying down the first layer of particles includes laying down particles of a first composition, and where the step of laying down the second layer of particles includes laying down particles of a first composition different from the first composition.

In some aspects, the techniques described herein relate to a method of manufacturing an in-mold manufactured article, further including the step of post-processing the in-mold manufacturing article in a centrifuge.

In some aspects, the techniques described herein relate to a method of manufacturing an in-mold manufactured article, wherein the step of in-mold processing the first layer of particles includes controlling gas pressure of the closed mold of between zero (0) atm and one (1) atm.

In some aspects, the techniques described herein relate to a method of manufacturing an in-mold manufactured article, wherein the step of in-mold processing the first layer of particles includes heating the content of the mold to a temperature of at least 500° C.

In some aspects, the techniques described herein relate to a method of manufacturing an in-mold manufactured article, wherein the material includes at least 50% of one of: a) regolith, and b) 3d printing metal residue.

In some aspects, the techniques described herein relate to a method of manufacturing an in-mold manufactured article, wherein the non-regular particles have at least two of a) circularity value of less than 0.89, b) a convexity value of less than 0.99, and an elongation value of more than 0.10.

In some aspects, the techniques described herein relate to a method of manufacturing an in-mold manufactured article, wherein the non-regular particles have at least two of a) an average circularity value of less than 0.89, b) an average convexity value of less than 0.99, and an average elongation value of more than 0.10.

In some aspects, the techniques described herein relate to an in-mold manufacture article manufactured using the present method, consisting in one of a filter and a thermal shield tile.

In some aspects, the techniques described herein relate to a filter, including a first face defined by the first manufactured layer and a second face opposed to the first face, wherein porosity of the filter is different about the first face from about the second face.

In some aspects, the techniques described herein relate to a thermal shield tile, wherein the first manufactured layer is a gas tight layer, and the second manufactured layer is a porous layer adjoining the first manufactured layer.

In some aspects, the techniques described herein relate to a thermal shield tile, including a first face defined by the first manufactured layer and a second face opposed to the first face, wherein the thermal shield tile includes a third manufactured layer being a gas tight layer defining the second face with the second manufactured layer located between the first manufactured layer and the third manufactured layer.

In some aspects, the techniques described herein relate to a thermal shield tile, wherein the second manufactured layer consists in a plurality of manufactured sub-layers.

In some aspects, the techniques described herein relate to a thermal shield tile, wherein at least one of the first manufactured layer and the third manufactured layer consists in a plurality of manufactured sub-layers.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic elevation view of a system for producing slags of regolith or 3d printing metal residues in accordance with an embodiment;

FIG. 2 is a side elevation view of an electro-chemical cell of the system of FIG. 1;

FIG. 3 is a detailed out view of a portion of the casing of the electro-chemical cell of FIG. 2 according to detail line -22-;

FIG. 4 is a perspective view of a hook piece of the casing of the electro-chemical cell of FIG. 2;

FIG. 5 is a perspective view of the electro-chemical cell of FIG. 2 connected to a water condenser according to the system depicted on FIG. 1;

FIG. 6 is a front view of the electro-chemical cell of FIG. 5 with a portion of an exhaust tube connected thereto;

FIG. 7 is a cross-section view of the electro-chemical cell of FIG. 2 according to cross-section line -26- depicted on FIG. 6;

FIG. 8 is a front view of an electrode adapted to be used in the electro-chemical cell of FIG. 1;

FIG. 9 is a cross-section view of the electrode of FIG. 2 according to the cross-section line -9- depicted on FIG. 2;

FIG. 10 is a perspective view of an additive manufacturing device (AMD) adapted for the manufacturing of regolith or 3d printing metal residues filters in accordance with an embodiment;

FIG. 11 is a front view of an additive manufacturing device (AMD) adapted for the manufacturing of regolith or 3d printing metal residues filters in accordance with an embodiment;

FIG. 12 is a side view of an additive manufacturing device (AMD) adapted for the manufacturing of regolith or 3d printing metal residues filters in accordance with an embodiment;

FIG. 13 is a perspective view of a heating element in accordance with an embodiment;

FIG. 14 is a top view of a heating element in accordance with an embodiment;

FIG. 15 is a side view of a heating element in accordance with an embodiment;

FIG. 16 is a schematic of a mold of the AMD of FIGS. 10-12;

FIG. 17 is a schematic cross-section view of the mold of FIG. 16 according to line -22-;

FIG. 18 is a perspective view of an upstream valve of the system of FIG. 1 in accordance with an embodiment;

FIG. 19 is an elevation view of the upstream valve of FIG. 18 with the inflatable element not inflated;

FIG. 20 is a cross-section view of the upstream valve of FIG. 19 with the inflatable element not inflated, according to line -20- depicted on FIG. 19;

FIG. 21 is an elevation view of the upstream valve of FIG. 18 with the inflatable element inflated;

FIG. 22 is a cross-section view of the upstream valve of FIG. 21 with the inflatable element inflated, according to line -20- depicted on FIG. 21;

FIG. 23 is a flow chart illustrating steps of an exemplary method of manufacturing a filter in accordance with an embodiment;

FIG. 24 is a flow chart illustrating steps of an exemplary method of manufacturing a thermal shield in accordance with an embodiment;

FIG. 25 is a perspective view of a lower section of the mold in accordance with an embodiment;

FIG. 26 is a plan view of the mold of FIG. 25;

FIG. 27 is a front elevation view of the mold of FIG. 25;

FIG. 28 is a cross-section view of the mold of FIG. 27 according to line -28- depicted on FIG. 27;

FIG. 29 is a perspective view of a top section designed to interact with the mold of FIG. 25 in accordance with an embodiment;

FIG. 30 is a plan view of the mold of FIG. 29;

FIG. 31 is a front elevation view of the mold of FIG. 29;

FIG. 32 is a cross-section view of the mold of FIG. 31 according to line -32- depicted on FIG. 31;

It will be noted that throughout the appended drawings, like features are identified by like reference numerals.

### DETAILED DESCRIPTION

Embodiments will now be described more fully hereinafter with reference to the accompanying figures, in which embodiments are illustrated. The foregoing may, however, be embodied in many different forms and should not be construed as limited to the illustrated embodiments set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as”, or the like) provided herein, is intended merely to better illuminate the exemplary embodiments and does not pose a limitation on the scope of the embodiments. No language in the specification should be construed as indicating any unclaimed element as essential to the practice of the embodiments. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as “first”, “second”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “interior” and “exterior” and the like are intended to be construed in their normal meaning in relation with normal use of the devices.

It should further be noted that for purposes of this disclosure, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature.

It will be noted that throughout the appended drawings, like features are identified by like reference numerals.

In the context of metal production on the Moon and other low-gravity conditions, one object is to be able to perform in situ transformation of the resources available in oxygen, water, and metal, such that the resulting metal will be usable and valuable. Accordingly, the present device and method are directed to the production of metal, and more particularly to the production of device components used in the transformation of available regolith or 3d printing metal residues in valuable metal.

An object of the present description is devices and methods for the manufacturing a filter from material comprising non-regular particles, such as regolith or 3d printing metal residues, or material consisting of at least 80% of particles of size greater than 80 microns. The obtained filter is somewhat similar to ceramic filters used in various fields. In lunar embodiments, the regolith or 3d printing metal residues filters will be used to remove all sorts of impurities during the in situ production of metal.

Highland regolith has large amount of aluminum and silicon content, so during the production of metal, the slag resulting from electrolysis of regolith will contain both. While the electrolysis temperature needs to be elevated, the output temperature can be kept lower at a level where aluminum is liquid, yet silicon solidifies in a such a way that the liquid aluminum can be mostly filtered.

Loose micrometric metal powders are costly to handle securely, and the industry has to pay expensive services to dispose of these residues, aka by-products. By transforming those into blocks (porous or not), they become safer to dispose of, greatly reducing the cost of disposition. While simply turning those residues into blocks is sufficient for safer disposition, the production of useful parts (air/liquid filters, thermal shielding tiles) from such residues is a higher-value proposition.

Therefore, the present description applies to the use of e.g., regolith, 3d printing metal residues, or alike to manufacture filters having the desired characteristics.

The spent filters will typically be full of oxides and silicon. It is an object to make them hexagonal, easing the tiling of the spent filters as a still valuable manufactured article, as a spent filter or directly as a manufactured article manufactured through the present manufacturing process, in applications such as: heat shielding tiles, landing pad tiles, road tiles, construction bricks, etc. Thus, manufactured articles are planned to have an initial value first based on the filtering qualities and afterwards as e.g., a construction material, or alternatively directly as e.g., a construction material. It is worth explaining that filters being porous while having good mechanical properties can also be used as thermal shielding tiles with minimal modifications. Lunar regolith and 3d printing metal residue, have excellent thermal characteristics due to their porosity. By fully melting the last layers of a partially fused tile, a gas tight interface is created with high thermal insulation being therethrough provided. Since there are companies planning on producing metal and operating 3d metal printer on the Moon, both the raw lunar regolith and the residues from these processes can be reused, recycled, and combined for parts production. Reusing and recycling discarded outputs from one process to feed another is something to which for, improving value of the manufactured article, and crucial in space context where waste management would be of upmost importance.

It is also worth mentioning that in e.g., the lunar context, silicon in spent filters could be partly recovered by reheating the spent filters in a centrifuge. If the processed (filtered) material contains mostly silicon and little aluminum content, it should be operated at a higher temperature to let the silicon pass while still filtering oxides. The resulting output would be mostly silicon, which is also valuable.

In this lunar environment, it is necessary to have an unending source of filters. The following describes devices and methods for manufacturing the filters from lunar regolith or 3d printing metal residues, and preferably from only regolith, and the “exotic” aluminum alloy produced thereby as the metallic product of the use of the regolith or 3d printing metal residues filters.

The device and method are based on the principle of partial fusion of particles of e.g., lunar regolith or 3d printing metal residues, preferably mixed with a small ratio of metal powder, in either reduced gravity environment (e.g., lunar environment) up to a normal gravity environment (e.g., terrestrial environment) to mass-manufacture e.g., hexagonal, filters.

Since lunar regolith or 3d printing metal residues is highly porous and very angular, particles of lunar regolith, 3d printing metal residues, or alike can hook to similar particles and is thus partially self-supporting. Loose regolith or 3d printing metal residues is therefore full of voids. Processing the regolith or 3d printing metal residues allows, while allowing to maintain some characteristics, to obtain filters able through some level of cohesion to support a process through which slags are pushed therethrough without the processing of the slags destroying the filters. To manufacture the regolith or 3d printing metal residues into a usable filter, the described method involves at least partially fusing the particles of material, e.g., regolith or 3d printing metal residues, according to manufacturing conditions to maintain control over the final characteristics of the resulting filters.

In a preferred embodiment, the article of manufacture is produced using lunar regolith, 3d printing metal residues, or alternative non-regular particle material, wherein a substantial proportion, e.g., more than 25%, more than 50%, more than 60%, more than 70%, or more than 75%, have the following characteristics placing them in a category of non-regular particles. A first characteristic is circularity, with the particles have a value of less than 0.89, less than 0.75, or preferably less then 0.67. A second characteristic is convexity, with the particles having a value of less than 0.99, less than 0.96, and preferably less than 0.75. A third characteristic is elongation, with the particles having a value of more than 0.10, more than 0.15, and preferably more than 0.20. Preferably, particles feature at least two of the three characteristics having values in the preferred listed ranges to provide the desired porosity.

According to another embodiment, the article of manufacture is produced using material consisting in a mix of at least 60% of particles of a size greater than 80 microns, at least 80% of particles of a size greater than 80 microns, at least 85% of particles of a size greater than 80 microns, and preferably at least 90% of particles of a size greater than 80 microns.

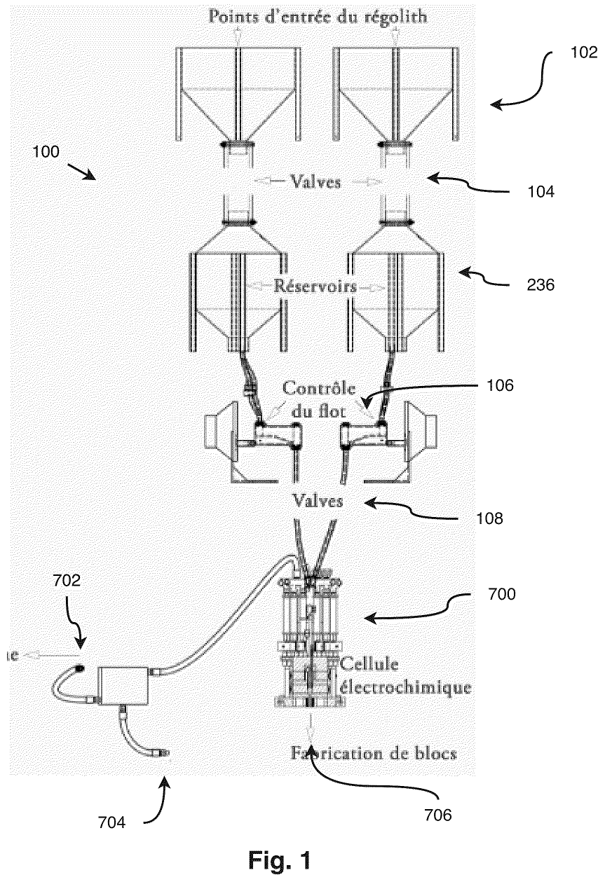

Referring now to the drawings, and more particularly FIG. 1, the in situ production system 100 comprises regolith or 3d printing metal residues feeding components 102, upstream valves 104, reservoirs 236, flow control system 106, downstream valves 108, an electro-chemical cell 700 as described below, wherein processing of the regolith or alike through that system 100 permits to generate oxygen 702, water 704 and slags of pre-processed regolith, aka regolith slags 706 that need to be post-processed using the manufactured filters to obtain valuable material.

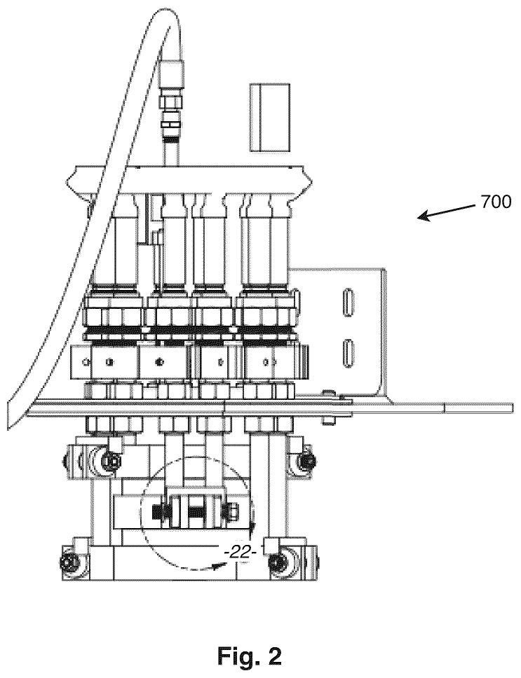

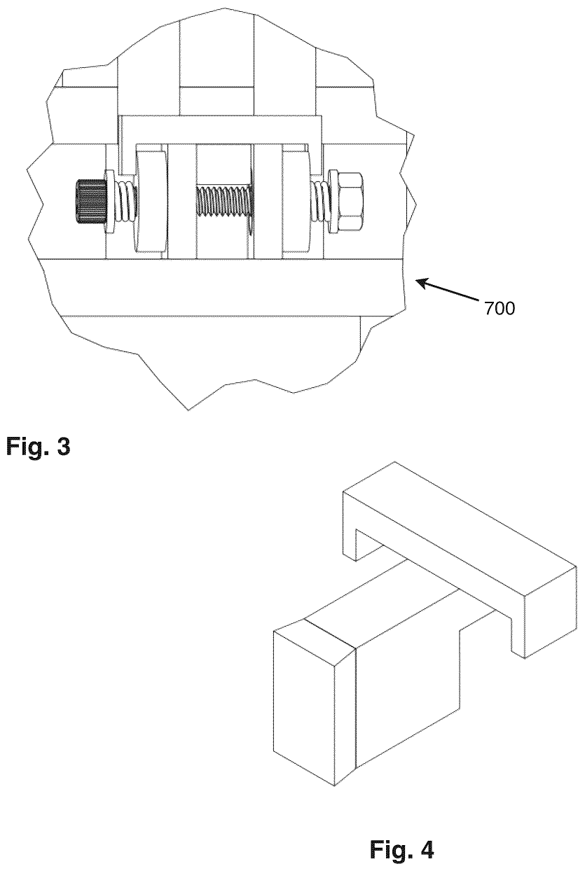

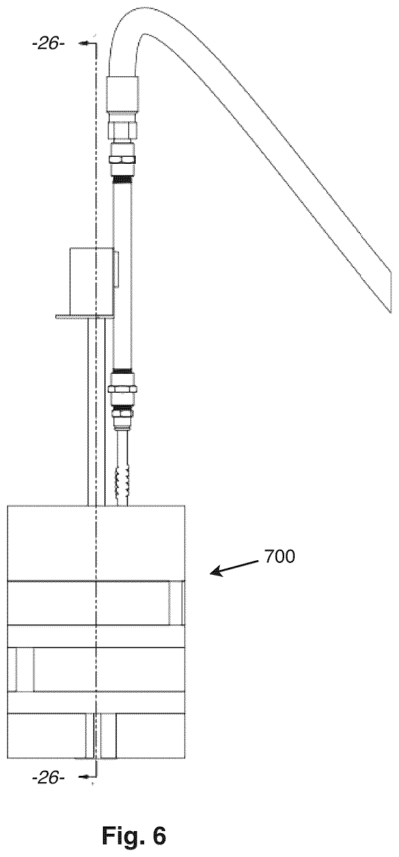

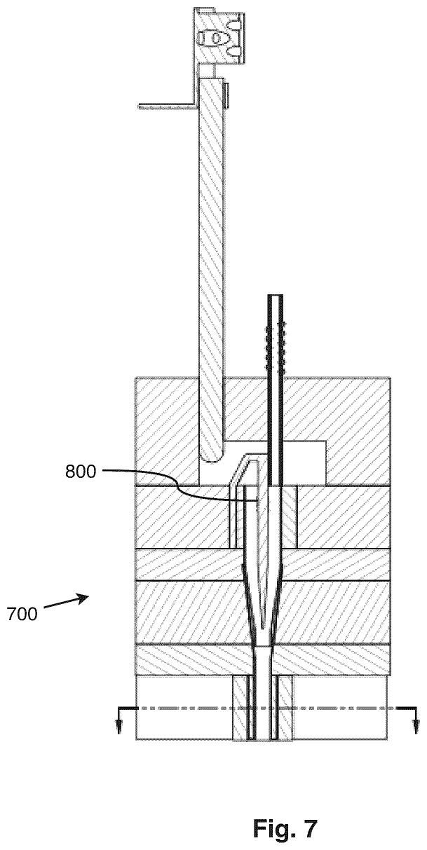

Referring to FIGS. 2-7, the electro-chemical cell 700, aka heating head, as described in U.S. Pat. No. 11,260,590 from the Applicant is preferably used to extract oxygen and water from regolith, and the intermediary product, regolith slag 706, wherein the regolith slags 706 is intended to be the subject of post-processing, aka filtering to obtain metal.

According to an embodiment, the electro-chemical cell 700 used to generate the regolith slag 706 from regolith is calibrated to extract optimum amount of oxygen. Efficiency, and more particularly energetic efficiency of the process is modified therethrough.

The regolith slag generated by the electro-chemical cell is pushed through e.g., a locally produced filter, using the pressure from the generated gases at top of the cell.

Post-processing of the filtered metal, according to an embodiment, would involve pressing out the content as a, e.g., wire extrusion, and using a mass spectrometer, or another appropriate measuring instrument, to determine the content of sections of the wire. The sections would be cut into segments sorted by content, e.g., based on main content and purity.

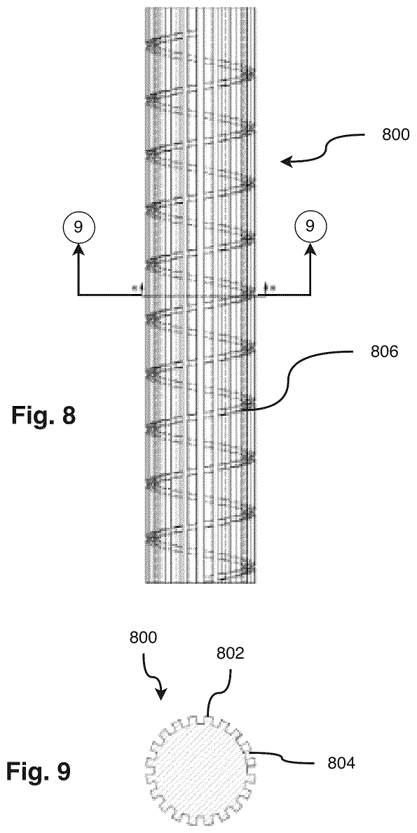

Referring now to FIGS. 8 and 9, the electro-chemical cell 700 comprises an electrode 800 having an unregular exterior face comprising a series of generally vertical ribs 802 separating channels 804 of e.g., under 1 mm, and preferably less, and more preferably about 300 microns of arch. The surface tension of liquid regolith would result in the regolith not fully penetrating in the channels 804, the portion of the channels 804 free of regolith providing a lower resistance path for gas to rise in the electrolysis chamber as the electrolysis process takes place.

According to a preferred embodiment, the conduit used for the gas escape channel 804 has a high contact angle (wetting angle) while the material in contact with the molten oxide has a low contact angle. The alternance of low and high contact angles creates escapes routes for the gas that would otherwise detach the molten oxide from the reducing electrode, lowering efficiency.

While FIG. 9 shows a cylindrical electrode, a similar construct can be made for a rectangular, flat plate electrode, or a conical electrode, by topology morphing.

According to an embodiment, the vertical channels 804 are complemented with one or more helicoidal channels 806 that would complement the vertical channels 804 as resistance-less path for the gas to rise.

It is worth mentioning that resistance of the material, e.g., the regolith or 3d printing metal residues, to the rise of the gas increases with the length of the electrode 800. Accordingly, the number, the dimensions, and the configuration of the channels 804 and/or 806 would be established according to the length of the electrode and the characteristics of the material subject to the electrolysis process.

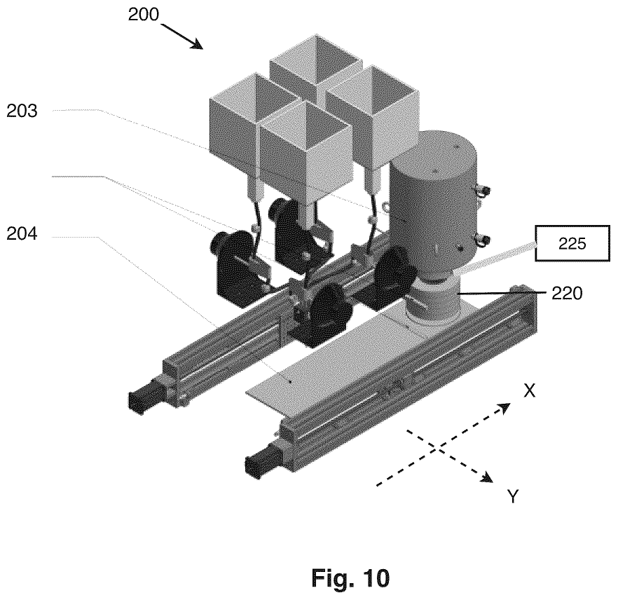

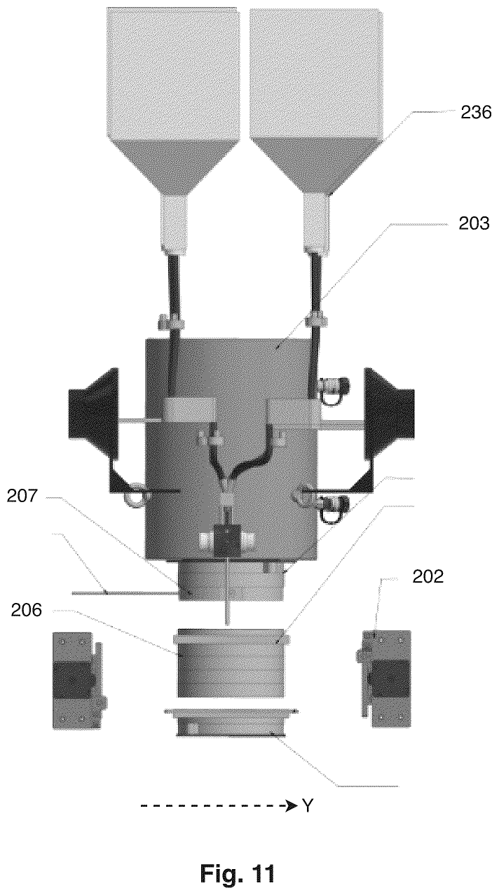

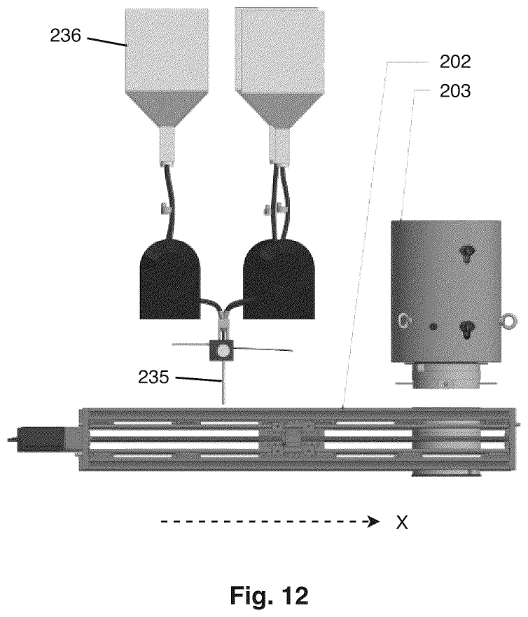

Referring to FIGS. 10-12, an Additive Manufacturing Device 200, aka AMD 200, similar in some aspect to the one described in patent application publication number US 2021/0362239 A1 of the same Applicant, is adapted for manufacturing manufactured articles, and particularly manufactured filters, e.g., regolith or 3d printing metal residues filters, by depositing material, e.g., regolith or 3d printing metal residues (in powder or particle form) in a mold, layer-by-layer, and in-mold processing the layers of material. Through a combined use of heat, or pressure and heat, when in the mold, aka in-mold processing, the layers are processed while avoiding turbulence (that may result from other manufacturing techniques) that could dramatically alter the shape and characteristics of the resulting manufactured filter.

The AMD 200 is designed to operate as a dual-station device having its own function. A first of the stations has a function of a high-pressure/high-temperature press. A second one of the stations has a function of a powder deposition printer.

To exert the regolith or 3d printing metal residues with repetitive in-mold processing, the AMD 200 is able to generate and/or use a high-pressure gas pressing process performed between depositions of layers. A high-tonnage hydraulic cylinder 203 is used to close a mold 220, which is then pressurized by injecting inert gas using a compressor 225; the inert gas being at a higher pressure than what the hydraulic cylinder 203 can provide alone. According to examples, the compressor 225 provides a pressure that is more than 3 times, and up to 4 times the maximum pressure the hydraulic cylinder generates when closing the mold 220.

It is to be noted that, according to embodiments and operating conditions, as the layer manufactured, the AMD 200 may operate with controlled gas pressure or not, aka with low pressure gas or of pressurized gas without departing from the described method.

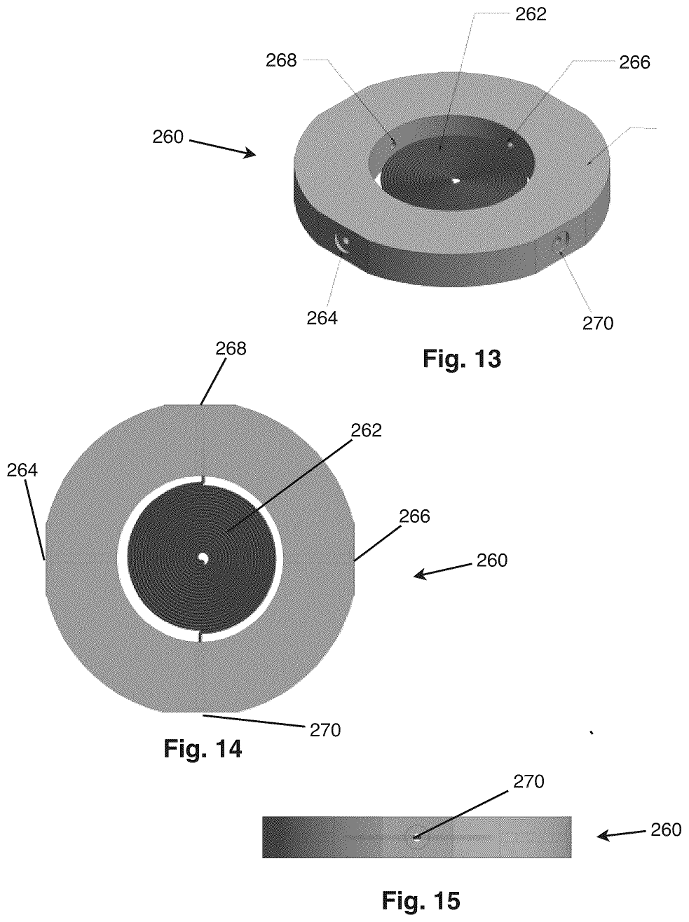

Referring additionally to FIGS. 13-15, a heating element 260 that is not adjoining the material, increases the pressure once the gas is injected, pressurized, and the gas inlet valve is closed. The heating element 260 comprises a heating coil 262 connected at one end to an electric inlet 264 and at its other end to an electric outlet 266. The heating element 260 further comprises a gas inlet 268 and a gas outlet 270 with a compressor 225 connected thereto, and valves to place the mold 220 into and out of a pressurized state.

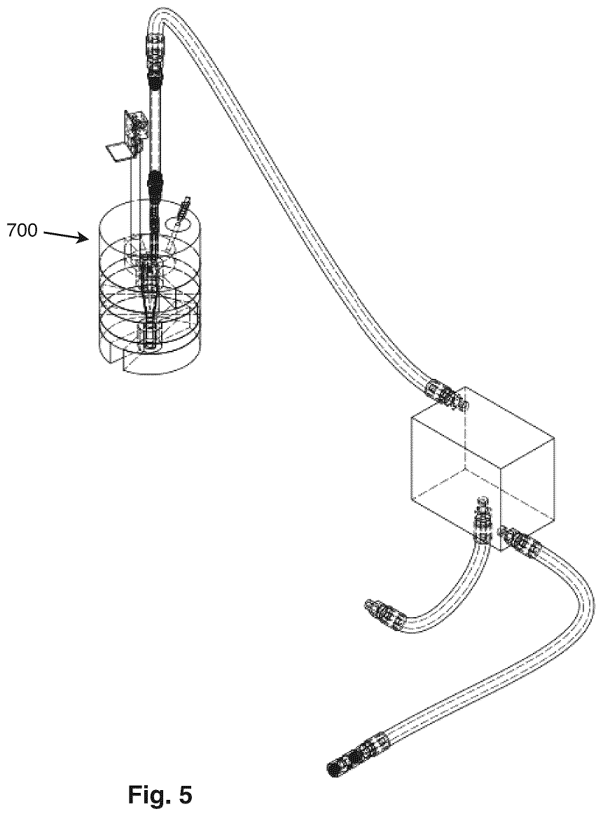

The heating element 260 typically consists in one of the plates of the mold 220, and preferably one plate pressed against the open top of the mold 220 to close the mold 220, According to an embodiment depicted, e.g., on FIG. 5, the heating element 260 is part of or embodies the output plate 207 pushed against the mold 220 by the hydraulic cylinder 203.

Heat, and/or combined action of controlled gas pressure and of heat, controlled to be within operational parameters, permits to gradually, aka layer by layer, manufacture a manufactured article, e.g., filter from particles of material, e.g., regolith, 3d printing metal residues, or alike. The resulting manufactured filter features both the resistance required to undergo an operational pressure exerted by a regolith slag thereover without losing physical cohesion, and the porosity for allowing material from the regolith slag to travel therethrough during a metal production post-processing.

Preferably, the manufactured filter has a thickness of at least two (2) cm, and preferably three (3) cm or more, and a diameter or a minimum size perpendicular to the layering direction, of at least five (5) cm, and preferably of seven (7) cm or more.

Preferably, the manufactured filter is made of between one (1) and one thousand (1000) layers, and preferably a number of at least one hundred (100) layers manufactured subsequently over the preceding one when manufactured from e.g., regolith, 3d printing metal residues, or alike.

It is worth mentioning that the method of manufacturing manufactured filters involves the use of e.g., solid regolith, 3d printing metal residues particles, or alike, of layering at least one, and preferably a plurality of layers of the particles, and of in-mold processing of the layer(s) of particles with heat or combined heat and pressure such as avoiding melting the particles but still having the particles of regolith or 3d printing metal residues undergoing some level of fusion therebetween such that the size and density of the voids between the particles of regolith or 3d printing metal residues and the general characteristics of the manufactured filter provide the desired cohesion and filtering characteristics.

It is herein contemplated that the method described herein is better adapted for normal gravity and no-gravity production. Lower gravity conditions help in achieving the desired thickness of a filter having the desired cohesion and filtering characteristics. For instance, lower gravity helps in achieving a thicker filter having similar filtering characteristics.

However, in a higher gravity environment, extra care must be taken to prevent the particles from packing, which would change the characteristics of the manufactured object. The heating profile must also be adapted to prevent the layer being melted from sagging. While the final characteristics will change with different gravities, parameters used in the process can be adjusted to compensate at least partially for it.

Once properly cooled down, the manufactured filter may be used in application described e.g., in “Industrial Applications of open core ceramic foam for molten metal filtration”, 2013, https://books-library.net/files/books-library.net-12262340Wj7L4.pdf in e.g., the process of extracting metal from lunar regolith and purifying the extracted metal.

Furthermore, the manufacturing process allows, in some embodiments, depositing precursors of the regolith or 3d printing metal residues for in situ material production.

For manufacturing another manufactured article such as, e.g., a thermal shield tile, a similar AMD 200 is used. In order to manufacture a thermal shield tile, at least one layer, e.g., a first layer defining a first face of the manufactured thermal shield tile, or preferably the two faces of the manufactured thermal shield tile perpendicular to the layering deposition direction, are manufactured to be gas tight, while the other layers, being partially fused and featuring a good porosity, present great insulation characteristics.

According to an embodiment, the AMD 200 is adapted to control at least one of the temperature and the pressure applied during the fusing process of one layer to generate either an air tight layer or a layer with porosity, regardless of the characteristics applied during the generation of the preceding and/or the subsequent layer.

According to a preferred embodiment, the AMD 200 is adapted to apply a combination of temperature and pressure of a first range 0˜1200° C. and 0˜1 ksi for generating a porous layer, wherein the thickness of the porous layer is preferably within a range of between 50˜200 μm when made with regolith or 3d printing metal residues.

According to a preferred embodiment, the AMD 200 is adapted to apply a combination of temperature and pressure of a second range 0˜1800° C. and 0˜20 ksi for generating a gas tight layer, wherein the thickness of the gas tight layer is preferably within a range of between 50˜200 μm when made with regolith or 3d printing metal residues.

According to a preferred embodiment, the manufactured thermal shield tile is made of between two (2) and two hundred (200) layers, more preferably a minimum of three (3) layers with at least one (1) porous layer disposed between two (2) gas tight layers, and preferably a number of at least one hundred (100) layers manufactured subsequently over the preceding one when manufactured from regolith or 3d printing metal residues.

According to an embodiment, the gas tight layers are made with the use of pressurized gas, while the porous layers are made either with e.g., less pressurized gas, or alternatively without the use of pressurized gas or even with low pressure gas. According to an embodiment, the controlled gas pressure used to manufacture the gas tight layers is greater than the pressure of the regulated gas pressure used to manufacture the porous layers, the pressure providing some help in the compaction of the particles that, when heated, generate the air tight layer.

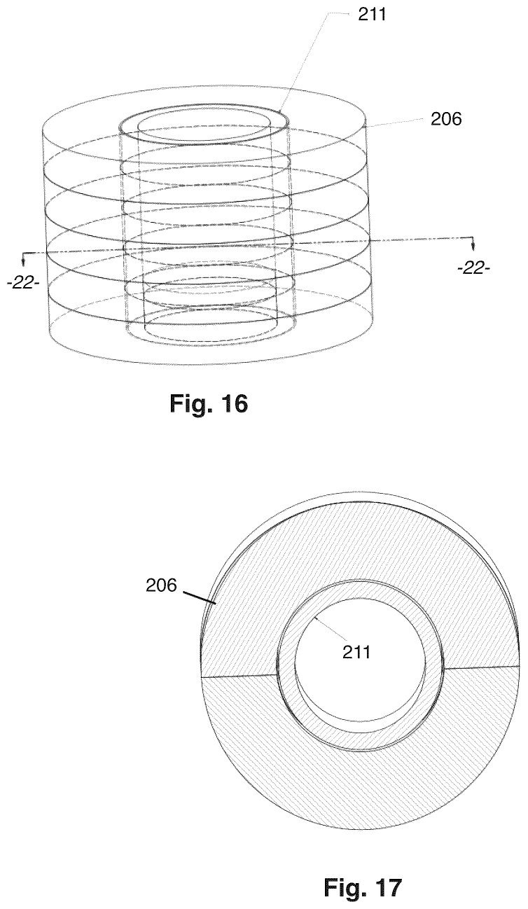

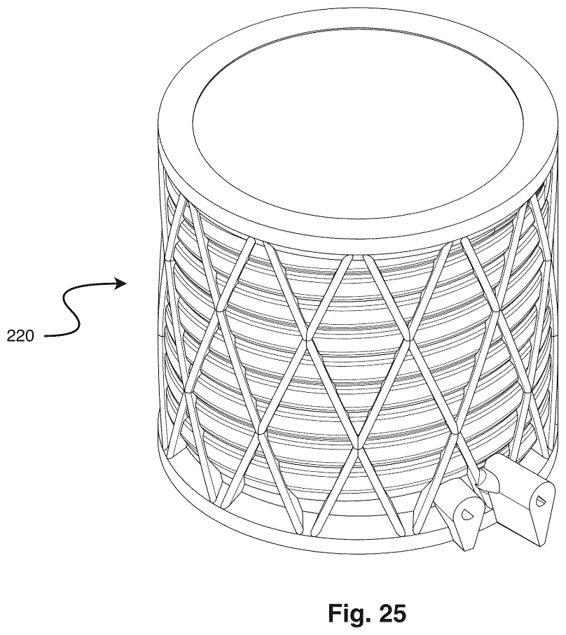

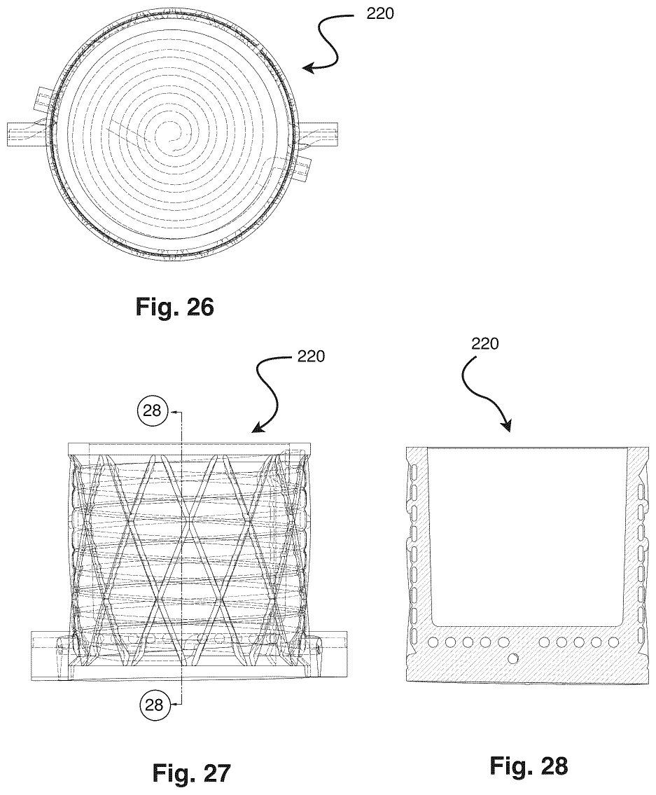

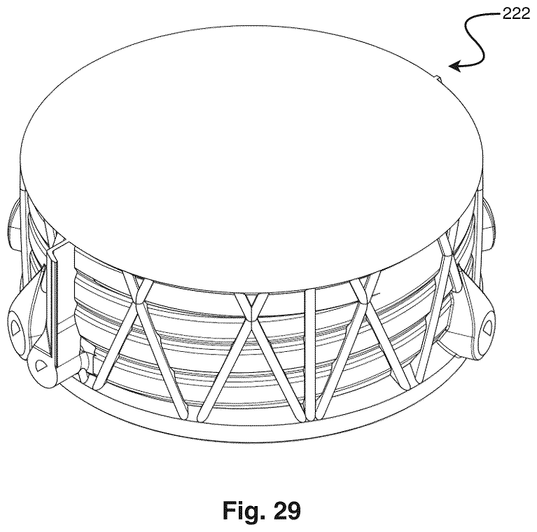

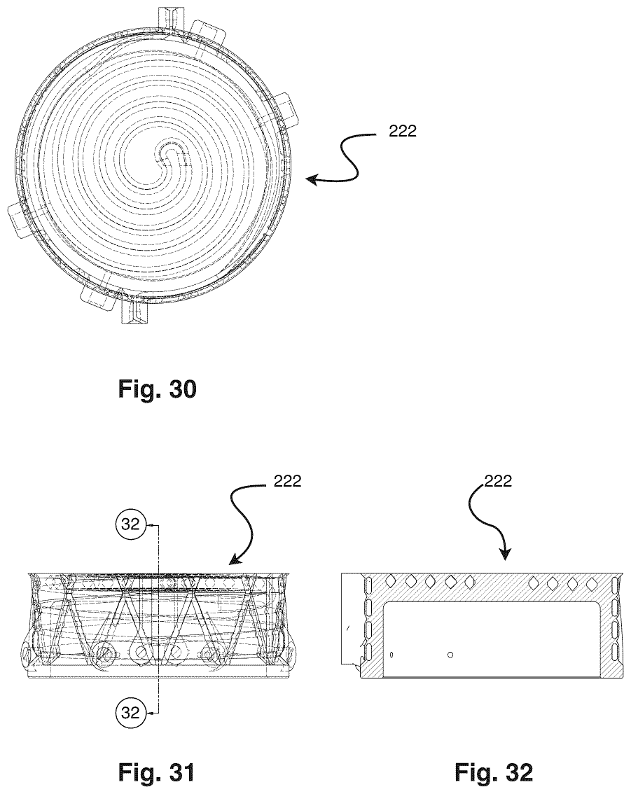

Referring to FIGS. 16-17, and additionally to FIGS. 25 to 32, the design of the mold 220 (depicted as circular perpendicular to the deposition direction, regardless of being preferably hexagonal) is typically made up of several metal plates 206, with e.g., metal gaskets installed between the plates 206.

The mold 220 interacts with a lid portion 222 designed to be mounted to the mold 220 to define together an enclosure. As depicted, the mold 220 and the lid 222 may comprise electrical inlets and outlets, and gas inlets and outlets to process the content of the enclosure.

Not depicted, the mold 220 has preferably of a hexagonal shape for the spent filter to have post-production additional value discussed before based on the ease to assemble hexagonal components.

Referring now to FIG. 1 and FIGS. 10-12, it is a preferred embodiment to use a plurality of reservoirs 236 to contain e.g., regolith or 3d printing metal residues feeding the AMD 200. The reservoirs 236 are preferably positioned at the top of the AMD 200 with gravity participating in driving the flow of regolith or 3d printing metal residues toward the AMD 200. The bottom part of each reservoir 236 is connected to a guiding tube having a vibrating part connected thereto. The other end of the guiding tube is connected to a flow controller. The regolith or 3d printing metal residues is guided into a tube for depositing into the mold 220. Multiple reservoirs 236 allows to use different materials, e.g., metal powder to mix with regolith or 3d printing metal residues, or material characteristics, e.g., particle size, through the filterer manufacturing process, and to fill a reservoir 236 from a feeding component 102 when another reservoir 236 is being used to layer regolith or 3d printing metal residues.

Referring to FIGS. 10-12, the mold 220, which is designed to receive the regolith or 3d printing metal residues, is mounted onto a sliding plate 204 whereby the mold 220 translates in a X-Y plane through motion of the plate 204 by two motorized rails 202, between the first station adapted for powder deposition operations, and the second station adapted for the in-mold processing operations.

Referring to FIGS. 16-17, in one embodiment the mold 220 comprises graphite filling parts, e.g., graphite-impregnated packing seals. The mold 220 is made from multiple plates 206, comprising a top cooling plate and a bottom cooling plate, pressure diffusing plates, and an input/output plate with connectors for electric power and gas distribution. The moving mold 220 further comprises a refractory sleeve 211 to protect the plates 206.

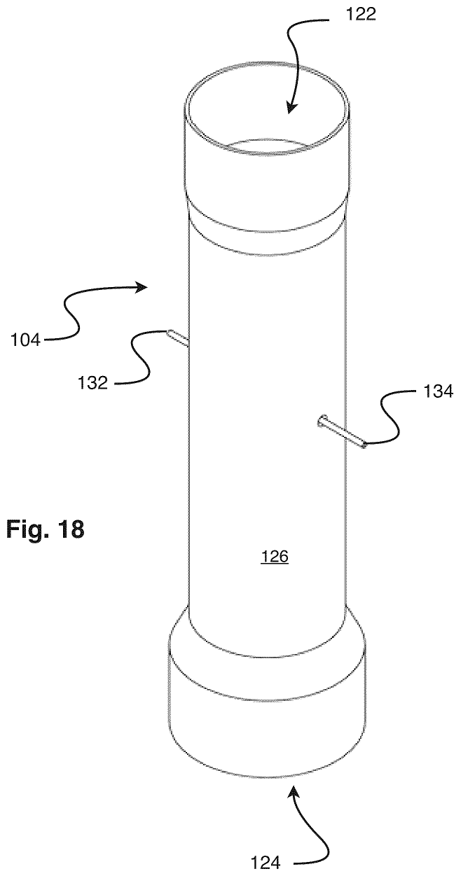

Referring to FIGS. 18-22, upstream valves 104 are adapted to controllably restrain the flow of regolith or 3d printing metal residues to face the temperature gradian existing between the material input of the feeding components 102 and the material input of the AMD 200 or the electro-chemical cell 700 depending on the system used.

The upstream valve 104 has an input 122, an output 124 and a body 126 extending between the input 122 and the output 124. A pair of inflating tubes 132, 134 extend radially between the input 122 and the output 124 for controlling state of the upstream valve 104. By pumping in and out gas using the inflating tubes 132, 134, the system controls the state of each of the upstream valve 104, thereby controlling flow of regolith or 3d printing metal residues into the reservoirs 236.

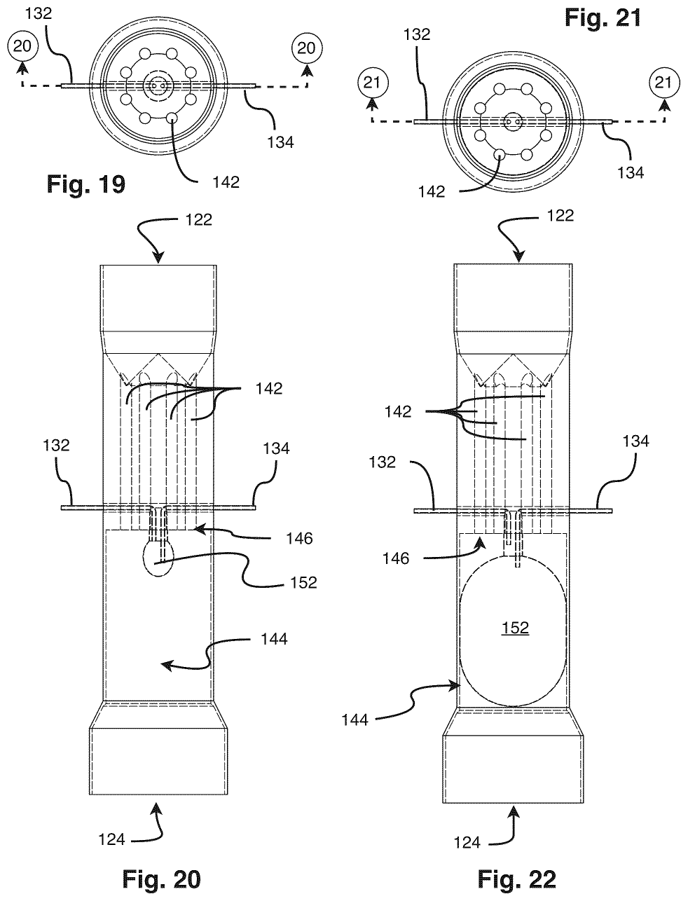

Referring particularly to FIGS. 19-20, the upstream valve 104 comprises a series of feeding channels 142 fluidly connecting the input 122 to a restrain portion 144. When the inflatable element 152 is not inflated, the restrain portion 144 is free of obstruction, providing a free path for the regolith or 3d printing metal residues to travel from the downstream extremity 146 of the channels 142 toward the output 124 of the upstream valve 104; the output 124 leading the regolith or 3d printing metal residues into a reservoir 236 where the regolith or 3d printing metal residues will be stored, and its temperature will rise slowly in a temperature-controlled environment.

Referring particularly to FIGS. 21-22, when the inflatable element 152 is fully inflated, the restrain portion 144 is occupied by the inflatable element 152, preventing a flow of regolith or 3d printing metal residues therethrough.

Accordingly, by controlling the pressure in the inflatable element 152 of the e.g., four upstream valves 104, it is possible to control both the input of regolith or 3d printing metal residues in the reservoirs 236 and the temperature of the regolith or 3d printing metal residues exiting the reservoirs 236 to feed the 600.

Method of Manufacturing Articles of Manufacture, e.g., Filters and Thermal Shield Tiles, from Regolith, 3d Printing Metal Residues, or Alike

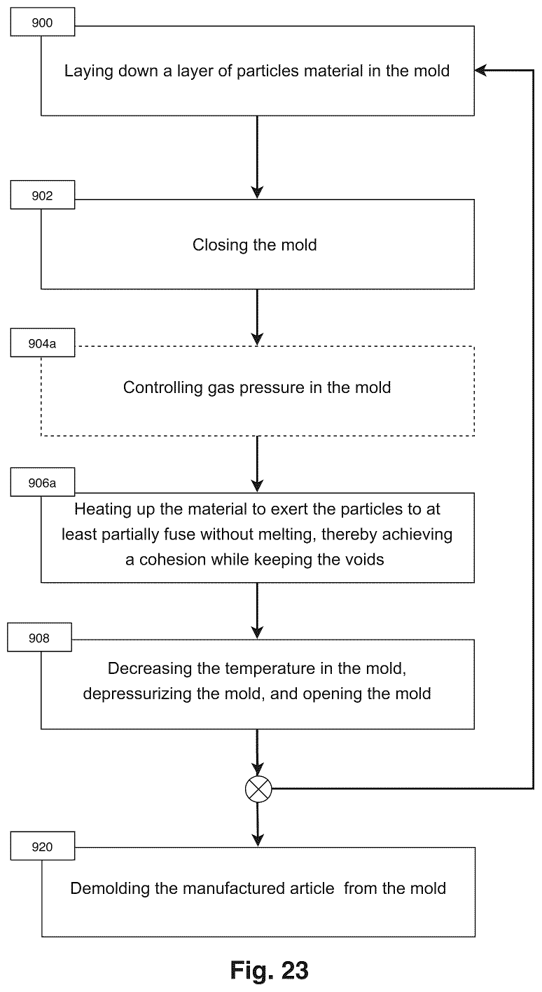

The use of the AMD 200 may be described as a method of manufacturing filters from regolith, 3d printing metal residues, or alike. The method, depicted on FIG. 23 for the manufacture of a manufactured filter of an embodiment, comprises:
Step 900 comprising laying down into the mold 220 a layer of material comprising one of non-regular particles of material, e.g., regolith or 3d printing metal residues, or a substantial portion of particles of greater size than 80 microns;
Step 902 comprising closing the mold 220;
Optional step 904a comprising controlling gas pressure, preferably inert gas, at a first pressure into the mold 220 to obtain e.g., a pressurized gas container;
Step 906a comprising heating up the material to a first temperature to exert the particles of the material to fuse at least partially with each other without a substantial portion of the material melting, thereby achieving a cohesion of the material while keeping the voids necessary for the filtering function of the layer of material. Resulting from the step 906a is a porous cohesive layer;
Step 908 comprising decreasing the temperature in the mold 220, depressurizing the mold 220 when pressurized, and opening the mold 220;
The method may comprise repeating the process as long as necessary by repeating step 900 of depositing another layer of material over the in-mold processed particles of material and repeating the other steps, step 902 and following, such as to manufacture, layer over layer, a manufactured article, e.g., a manufactured filter.

The method ends with step 920 comprising demolding the manufactured article from the mold 220.

Preferably, the manufactured article, e.g., the manufactured filter, undergoes a cool down period before use.

Manufacturing the manufactured filter layer by layer enables varying the filtering characteristics between its input face and its output face, allowing for coarser filtering characteristic about the input face and finer filtering characteristics at the output face of the manufactured filter. Such refinement of the characteristics of the different layers may be performed through the control of processing characteristics, namely, e.g., pressure, temperature and/or nature/characteristics of the material(s), etc.

Depending on the composition of the material used for the manufacture of the manufactured filter, and the chemical reactions that could happen (e.g., aluminum stealing oxygen from silica, yielding alumina and silicon), as a post-processing step, the manufactured filter can be reheated in a centrifuge the same way silicon is recovered by reheating the manufactured filters in a centrifuge.

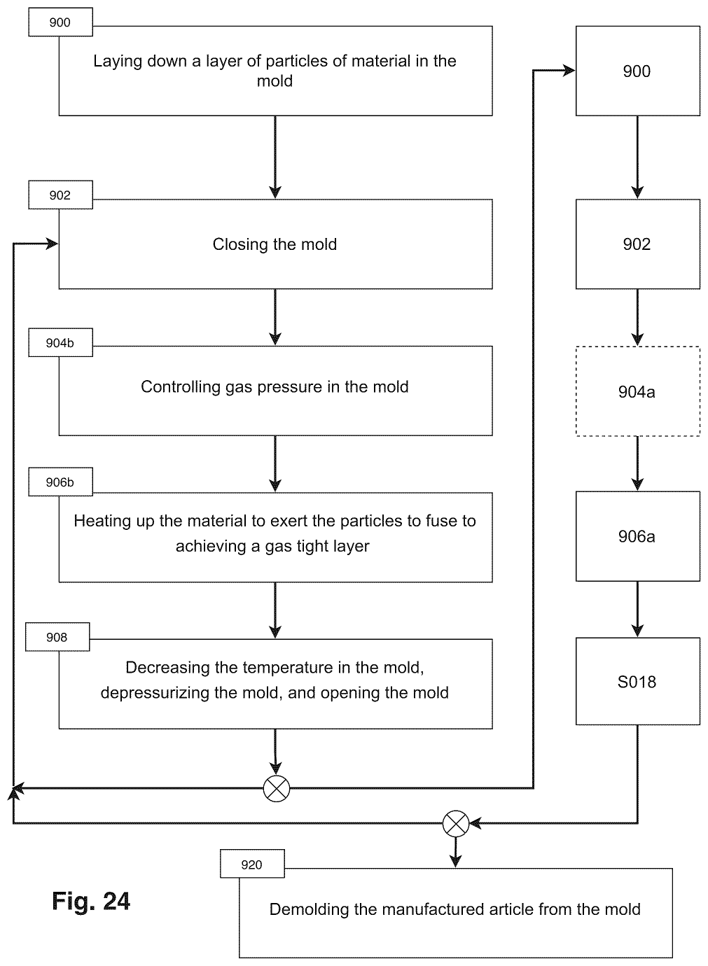

The use of the AMD 200 may be described as a method of manufacturing thermal shield tiles from material comprising one of non-regular particles such as regolith, of 3d printing metal residues or alike, or a substantial portion of particles of greater size than 80 microns. The method, depicted on FIG. 24 for the manufacture of a manufactured thermal shield tile of an embodiment, comprises:
Step 900 is similar as step 900 described for manufacturing a filter;
Step 902 is similar as step 902 described for manufacturing a filter;
Non-optional step 904b is similar as optional step 904a described for manufacturing a filter with regulated gas pressure at a second pressure;
Step 906b is similar as step 906a described for manufacturing a filter at a second temperature to obtain a gas tight cohesive layer;
Step 908 is similar as step 908 described for manufacturing a filter;
The method comprises repeating the process for at least a second layer to obtain a porous cohesive layer with the step 900, step 902, optional step 904a, step 906a, and step 908 described before.

The method comprises repeating the process for at least a final layer to obtain a final gas tight layer, wherein the steps are steps 900, 902, 904b, 906b, and 908 described before.

The method ends with step 920 comprising demolding the manufactured article, the thermal shield tile, from the mold 220.

It is worth mentioning that the method may include to generate a final gas tight layer, or alternating in a particular sequence the gas tight layers and the porous layers in order to obtain the article of manufacture having the desired characteristics.

It is worth mentioning that, since based on subsequent processing of layers, the description herein of manufacturing a layer may comprise manufacturing a series of sub-layers forming the described layer without departing from the present description.

Back to the method, preferably the method further comprises a step through which the manufactured article, e.g., the manufactured thermal shield time, undergoes a cool down period before use.

Manufacturing the manufactured thermal shield tile layer by layer enables varying characteristics of the layers, through e.g., control of processing characteristics, namely, e.g., pressure, temperature and/or nature of the material(s), additive, etc.

Kit for Extracting Metal from Regolith

According to an embodiment, there is disclosed a kit for manufacturing extracting metal from raw regolith. The kit comprises an electro-mechanical cell adapted for extracting air, water and regolith slabs from raw regolith; an in-mold processing assembly adapted for successive in-mold processing steps of overlaid layers of material, e.g., regolith or 3d printing metal residues, laid down in the mold, the in-mold processing comprising, after each layer, to heat up the content of the mold, or alternatively to inject pressurized gas into the mold and to heat up the under-pressure content of the mold to exert the particles of regolith to fuse at least partially with each other without the regolith melting to obtain a molded manufactured filter; and a regolith slag extraction assembly adapted to filter the regolith slag using the manufactured filter to obtain a filtered metal.

The method of using the kit is explained herein before.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method of manufacturing an in-mold manufactured article, comprising:
(a) laying down into a mold a first layer of particles of a material comprising at least one of a) at least 50% of non-regular particles, and b) at least 60% of particles of a size greater than 80 microns;
(b) closing the mold;
(c) in-mold processing the first layer of particles present in the mold by heating up content of the mold to exert the particles of the material to fuse at least partially with each other to generate a first manufactured layer;
(d) decreasing temperature;
repeating steps (a) to (d) at least once, whereby a second layer of particles of the material is laid over the first manufactured layer to obtain a second manufactured layer at least partially fused with the first manufactured layer; and
demolding the in-mold manufactured article comprising the first manufactured layer and the second manufactured layer,
wherein, in at least one of the first manufactured layer and the second manufactured layer, the particles are at least partially fused without having melt.

2. The method of manufacturing an in-mold manufactured article of claim 1, wherein the step of in-mold processing comprises controlling gas pressure into the mold.

3. The method of manufacturing an in-mold manufactured article of claim 2, wherein the step of in-molding processing the first layer of particles comprises fusing the particles into a cohesive gas tight manufactured layer.

4. The method of manufacturing an in-mold manufactured article of claim 1, wherein the step of in-molding processing the second layer of particles comprises fusing partially the particles into a cohesive porous manufactured layer.

5. The method of manufacturing an in-mold manufactured article of claim 1, wherein the step of in-mold processing the first layer of particles comprises controlling gas pressure to a first pressure, and wherein the step of in-mold processing the second layer of particles comprises controlling gas pressure to a second pressure lower than the first pressure.

6. The method of manufacturing an in-mold manufactured article of claim 1, wherein the step of in-mold processing the first layer of particles comprises heating the content of the mold to a first temperature, and wherein the step of in-mold processing the second layer of particles comprises heating the content of the mold to a second temperature different from the first temperature.

7. The method of manufacturing an in-mold manufactured article of claim 1, wherein the step of laying down the first layer of particles comprises laying down the particles into a first thickness of particles, and where the step of laying down the second layer of particles comprises laying down the particles into a second thickness of particles different from the first thickness of particles.

8. The method of manufacturing an in-mold manufactured article of claim 1, wherein the step of laying down the first layer of particles comprises laying down particles of a first composition, and where the step of laying down the second layer of particles comprises laying down particles of a first composition different from the first composition.

9. The method of manufacturing an in-mold manufactured article of claim 1, further comprising the step of post-processing the in-mold manufacturing article in a centrifuge.

10. The method of manufacturing an in-mold manufactured article of claim 1, wherein the step of in-mold processing the first layer of particles comprises controlling the internal pressure of the closed mold of between zero (0) atm and one (1) atm.

11. The method of manufacturing an in-mold manufactured article of claim 1, wherein the step of in-mold processing the first layer of particles comprises heating the content of the mold to a temperature of at least 500° C.

12. The method of manufacturing an in-mold manufactured article of claim 1, wherein the material comprises at least 50% of one of: a) regolith, and b) 3d printing metal residue.

13. The method of manufacturing the in-mold manufactured article of claim 1, wherein the non-regular particles have at least two of a) circularity value of less than 0.89, b) a convexity value of less than 0.99, and an elongation value of more than 0.10.

14. The method of manufacturing the in-mold manufactured article of claim 1, wherein the non-regular particles have at least two of a) an average circularity value of less than 0.89, b) an average convexity value of less than 0.99, and an average elongation value of more than 0.10.

15. An in-mold manufacture article manufactured using the method of claim 1, consisting in one of a filter and a thermal shield tile.

16. The filter of claim 15, comprising a first face defined by the first manufactured layer and a second face opposed to the first face, wherein porosity of the filter is different about the first face from about the second face.

17. The thermal shield tile of claim 15, wherein the first manufactured layer is a gas tight layer, and the second manufactured layer is a porous layer adjoining the first manufactured layer.

18. The thermal shield tile of claim 17, comprising a first face defined by the first manufactured layer and a second face opposed to the first face, wherein the thermal shield tile comprises a third manufactured layer being a gas tight layer defining the second face with the second manufactured layer located between the first manufactured layer and the third manufactured layer.

19. The thermal shield tile of claim 18, wherein the second manufactured layer consists in a plurality of manufactured sub-layers.

20. The thermal shield tile of claim 18, wherein at least one of the first manufactured layer and the third manufactured layer consists in a plurality of manufactured sub-layers.
